(19) United States
(12) Patent Application Publication
(10) Pub. No.: US 2026/0255427 A1
(43) Pub. Date: Aug. 27, 2026

(54) COMMUNICATION METHOD AND APPARATUS, AND DEVICE AND STORAGE MEDIUM

(71) Applicant: Beijing Xiaomi Mobile Software Co., Ltd., Beijing (CN)

(72) Inventor: Yajun CHENG, Beijing (CN)

(73) Assignee: Beijing Xiaomi Mobile Software Co., Ltd., Beijing (CN)

(21) Appl. No.: 19/160,126

(22) PCT Filed: Feb. 28, 2023
(86) PCT No.: PCT/CN2023/078816

§ 371 Date: Aug. 27, 2025

(51) Int. Cl. H04W 76/20; H04W 24/02

(52) U.S. Cl. CPC H04W 76/20; H04W 24/02

(57) ABSTRACT

The embodiments of the present disclosure relate to the technical field of communications, and provide a communication method and apparatus, and a device and a storage medium, which can be applied to an AP MLD. The method comprises: determining a first message frame, wherein the first message frame comprises a first information domain, and the first information domain is used for respectively indicating that an operation parameter update request corresponding to each first communication connection is approved or rejected, and is used for indicating the number of first communication connections, or, the first message frame comprises a second information domain and a third information domain, the second information domain is used for respectively indicating that an operation parameter update request corresponding to each first communication connection is approved or rejected, and the third information domain is used for indicating the number of first communication connections, each first communication connection being a communication connection for a non-access point multi-link device (Non-AP MLD) to request that a multi-link operation parameter update is performed; and sending the first message frame. The embodiments of the present disclosure can provide a method for an AP MLD to respectively respond to an operation parameter update request corresponding to one or more communication connections.

### TECHNICAL FIELD

The embodiments of the present disclosure relate to the field of communication technology and, specifically, to a communication method, an apparatus, a device and a storage medium.

### BACKGROUND

To achieve higher throughput, lower network latency and higher reliability, wi-fi 7 introduces multi-link operation (MLO) technology. Devices that support the MLO function are called multi-link devices (MLD), including access point multi-link device (AP MLD) and non-access-point multi-link device (Non-AP MLD). Based on MLO technology, multiple communication links can be established between Non-AP MLD and AP MLD across frequency bands.

When AP MLD adds or removes an attached AP, enables a communication link or invalidates a communication link, Non-AP MLD is to initiate, through a multi-link operation update request frame, an operation parameter update request for each communication link involved. However, in the prior art, AP MLD can only reject or approve all operation parameter update requests at the same time, and cannot respectively respond to the operation parameter update requests corresponding to each communication link.

### SUMMARY

The embodiments of the present disclosure provide a communication method, an apparatus, a device and a storage medium, which can provide a way for an AP MLD to respectively respond to operation parameter update requests corresponding to one or more communication links.

In a first aspect, the embodiments of the present disclosure provide a communication method, being applied to an access-point multi-link device AP MLD and including:
determining a first message frame, where the first message frame includes a first information field, and the first information field is used for respectively indicating approval or rejection of an operation parameter update request corresponding to each first communication link, and is used for indicating a number of the first communication link; or,
the first message frame includes a second information field and a third information field, the second information field is used for respectively indicating approval or rejection of the operation parameter update request corresponding to each first communication link, and the third information field is used for indicating the number of the first communication link;
each first communication link is a communication link for a non-access-point multi-link device Non-AP MLD to request a multi-link operation parameter update; and
sending the first message frame.

In a second aspect, the embodiments of the present disclosure provide a communication method, being applied to a non-access-point multi-link device non-AP MLD and including:
receiving a first message frame, where the first message frame includes a first information field, and the first information field is used for respectively indicating approval or rejection of an operation parameter update request corresponding to each first communication link, and is used for indicating a number of the first communication link; or,
the first message frame includes a second information field and a third information field, the second information field is used for respectively indicating approval or rejection of the operation parameter update request corresponding to each first communication link, and the third information field is used for indicating the number of the first communication link;
each first communication link is a communication link for the Non-AP MLD to request a multi-link operation parameter update.

In a third aspect, the embodiments of the present disclosure further provide a communication apparatus, including:
a determining unit, configured to determine a first message frame, where the first message frame includes a first information field, and the first information field is used for respectively indicating approval or rejection of an operation parameter update request corresponding to each first communication link, and is used for indicating a number of the first communication link; or,
the first message frame includes a second information field and a third information field, the second information field is used for respectively indicating approval or rejection of the operation parameter update request corresponding to each first communication link, and the third information field is used for indicating the number of the first communication link;
each first communication link is a communication link for a non-access-point multi-link device Non-AP MLD to request a multi-link operation parameter update; and
a first communication unit, configured to send the first message frame.

In a fourth aspect, the embodiments of the present disclosure further provide a communication apparatus, including:
a second communication unit, configured to receive a first message frame, where the first message frame includes a first information field, and the first information field is used for respectively indicating approval or rejection of an operation parameter update request corresponding to each first communication link, and is used for indicating a number of the first communication link; or,
the first message frame includes a second information field and a third information field, the second information field is used for respectively indicating approval or rejection of the operation parameter update request corresponding to each first communication link, and the third information field is used for indicating the number of the first communication link;
each first communication link is a communication link for the Non-AP MLD to request a multi-link operation parameter update.

In a fifth aspect, the embodiments of the present disclosure further provide an electronic device, including a memory, a processor and a computer program stored in the memory and executable on the processor, where the processor is configured to implement the method according to any one of the embodiments of the present disclosure when executing the program.

In a sixth aspect, the embodiments of the present disclosure further provide a computer-readable storage medium storing a computer program, where the computer program, upon being executed by a processor, is used for implementing the method according to any one of the embodiments of the present disclosure.

The embodiments of the present disclosure provide a communication method, which allows the AP MLD respectively to indicate the approval or rejection of each operation parameter update request through a first message frame.

Additional aspects and advantages of the embodiments of the present disclosure will be partially given in the description below, which will become apparent from the description below, or will be learned through the practice of the present disclosure.

### BRIEF DESCRIPTION OF THE DRAWINGS

In order to more clearly illustrate the technical solutions of the embodiments of the present disclosure, the drawings required for use in the description of the embodiments of the present disclosure will be briefly introduced below. The drawings in the following description are only some embodiments of the present disclosure. For those skilled in the art, other drawings can be obtained based on these drawings without creative work.

FIG. 1 is a schematic structural diagram of a multi-link communication system according to an embodiment of the present disclosure.

FIG. 2 is a schematic flow chart of a communication method according to an embodiment of the present disclosure.

FIG. 3 is another schematic flow chart of a communication method according to an embodiment of the present disclosure.

FIG. 4 is an interactive schematic diagram of a communication method according to an embodiment of the present disclosure.

FIG. 5 is a schematic structural diagram of a communication apparatus according to an embodiment of the present disclosure.

FIG. 6 is a schematic structural diagram of a communication apparatus according to an embodiment of the present disclosure.

FIG. 7 is a schematic structural diagram of an electronic device according to an embodiment of the present disclosure.

### DETAILED DESCRIPTION

In some embodiments of the present disclosure, the term “and/or” describes the association relationship of associated objects, indicating that three relationships may exist. For example, A and/or B may represent three situations: A exists alone, both A and B exist, and B exists alone. The character “/” generally indicates that the associated objects before and after are in an “or” relationship.

The term “multiple” in some embodiments of the present disclosure refer to two or more than two, and other quantifiers are similar thereto.

Exemplary embodiments will be described in detail herein, examples of which are shown in the accompanying drawings. Unless otherwise indicated, when the following description refers to the drawings, the same numbers in different drawings represent the same or similar elements. The embodiments described in the following exemplary embodiments do not represent all embodiments consistent with the present invention. Instead, they are merely examples of apparatus and methods consistent with some aspects of the present invention as detailed in the appended claims.

The terms used in the present disclosure are for the purpose of describing specific embodiments only and are not intended to limit the disclosure. The singular forms “a”, “the” and “said” used in the present disclosure and the appended claims are also intended to include plural forms unless the context clearly indicates otherwise. It should also be understood that the term “and/or” used herein refers to and includes any or all possible combinations of one or more associated listed items.

It should be understood that although the terms first, second, third and the like may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the word “if” used herein may be interpreted as “upon” or “when” or “in response to determining”.

After AP MLD and non-AP MLD negotiate and successfully establish multi-link (multi-link setup), they can enable the established multi-link through the traffic-to-link mapping mechanism and invalidate some enabled links after enabling. In addition, AP MLD can add new subordinate APs or remove its subordinate APs to achieve communication link reconfiguration between AP MLD and Non-AP MLD. The addition of enabled communication links by AP MLD and the addition of new subordinate APs will increase the number of enabled communication links or established communication links between Non-AP MLD and AP MLD; invalidating enabled communication links and removing subordinate APs will reduce the number of enabled communication links or established communication links between Non-AP MLD and AP MLD. In these cases, the device capability information, of the STA attached to Non-AP MLD and the AP of AP MLD, is to be updated for better service transmission.

After AP MLD adds or removes subordinate APs, enables communication links, or invalidates enabled communication links, Non-AP MLD initiates a multi-link operation parameter update to update the operation parameters corresponding to the communication links involved. For example, it updates the maximum message protocol data unit (MPDU) and aggregate message protocol data unit A-MSDU that can be received by the STAs attached to the Non-AP MLD and in the communication links involved.

Non-AP MLD may specifically send a multi-link operation update request frame to AP MLD for multi-link operation parameter update request.

The multi-link operation update request frame includes at least a per-STA profile field, each per-STA profile field includes a STA control field, the STA control field includes a link ID field, and each link ID field indicates a communication link through an ID value, which is used for requesting an update of the operation parameters corresponding to the communication link, such as updating the device capability information of the STA corresponding to the communication link.

The multi-link operation update request frame includes a reconfiguration multi-link (information) element field, the multi-link information element field includes a link information (Info) field, and the link information field includes one or more per-STA profile fields.

After receiving the request frame, the AP MLD informs, through a message frame, the Non-AP MLD whether the request is successful. According to a typical mechanism, when the multi-link operation update request frame includes operation parameter update requests for multiple communication links, the AP MLD can only approve all or reject all operation parameter update requests included in the multi-link operation update request frame, and cannot selectively receive or reject a certain operation parameter update request.

To solve the foregoing problems, the technical solutions in some embodiments of the present disclosure are clearly and completely described below in conjunction with the drawings in some embodiments of the present disclosure. The described embodiments are only part of the embodiments of the present disclosure, not all of the embodiments. Based on the embodiments in the present disclosure, all other embodiments obtained by those skilled in the art without creative work shall fall within the protection scope of the present disclosure.

The method and the apparatus are based on the same disclosed concept. Since the principles of solving problems by the method and the apparatus are similar, the implementation of the apparatus and the method can refer to each other, and the repeated parts will not be elaborated.

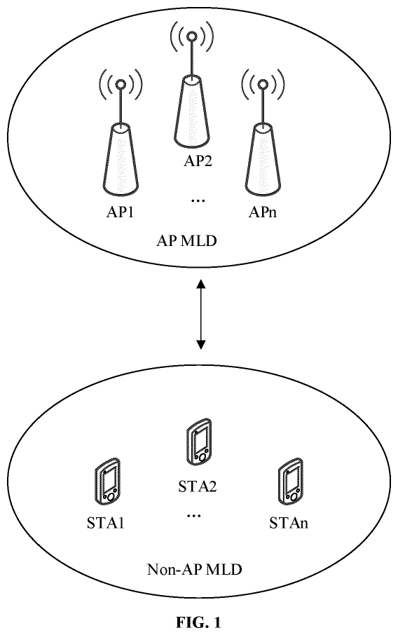

Referring to FIG. 1, which is a schematic structural diagram of a multi-link communication system according to an embodiment of the present disclosure. The system architecture includes at least one AP MLD and at least one Non-AP MLD. The AP MLD includes multiple AP devices, such as AP1, AP2, . . . , APn shown in FIG. 1. Non-AP MLD includes at least one STA device, such as STA1, STA2, . . . , STAn as shown in FIG. 1.

One or more communication links may be established between AP MLD and Non-AP MLD, and each communication link connects an AP device in AP MLD and an AP device in Non-AP MLD.

After AP MLD adds or removes subordinate APs, enables communication links, or invalidates enabled communication links, Non-AP MLD sends a multi-link operation update request frame to AP MLD to update the operation parameters corresponding to some communication links involved.

For example, AP MLD removes multiple subordinate APs, and Non-AP MLD sends a multi-link operation update request frame to AP MLD to request a multi-link operation update, that is, to request an update of the operation parameters corresponding to the remaining communication links between AP MLD and Non-AP MLD after removing the subordinate APs.

For AP MLD, it determines and sends a first message frame to Non-AP MLD, and responds, through the first message frame, to the operation parameter update request corresponding to each communication link in the multi-link operation update request sent by Non-AP MLD. In addition, the first message frame is further used for indicating the number of communication links corresponding to the operation parameter update request responded by AP MLD, that is, indicating the number of communication links that the AP MLD rejects or approves for the corresponding operation parameter update requests. In some embodiments of the present disclosure, the AP device may be a wireless switch for a wireless network, or an access device for the wireless network. The AP device may include software applications and/or circuits, thereby enabling other types of nodes in the wireless network to communicate with the outside and inside of the wireless network through the AP device. As an example, the AP device may include a terminal device or a network device equipped with a wi-fi chip.

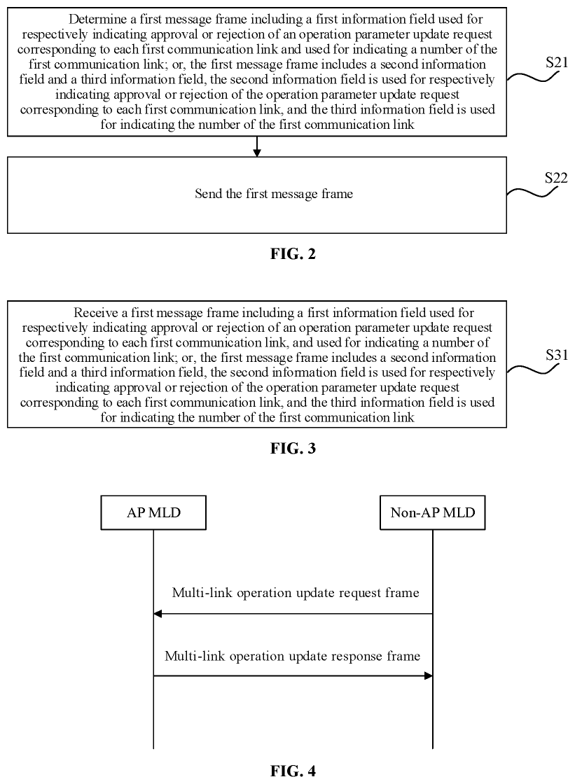

STA devices may specifically include but are not limited to: cellular phones, smart phones, wearable devices, computers, personal digital assistants (PDAs), personal communication system (PCS) devices, personal information managers (PIMs), personal navigation devices (PNDs), global positioning systems, multimedia devices, internet of things (IoT) devices, and the like. The embodiments of the present disclosure provide a communication method that can be applied to AP MLD. Referring to FIG. 2 for details, it is a schematic flow chart of a communication method according to an embodiment of the present disclosure.

Optionally, the method may include the following step(s).

In step S21, a first message frame is determined, where the first message frame includes a first information field, and the first information field is used for respectively indicating approval or rejection of an operation parameter update request corresponding to each first communication link, and is used for indicating the number of the first communication link; or, the first message frame includes a second information field and a third information field, the second information field is used for respectively indicating approval or rejection of the operation parameter update request corresponding to each first communication link, and the third information field is used for indicating the number of the first communication link. In some embodiments of the present disclosure, each first communication link is a communication link for a Non-AP MLD to request a multi-link operation parameter update.

The first communication link is the communication link for which the Non-AP MLD requests to update the multi-link operation parameters, including but not limited to the communication link established between the AP device, after being added by the AP MLD, and the STA attached to the Non-AP MLD, the remaining established communication link between the AP device and the STA attached to the Non-AP MLD after the AP MLD removes the attached AP device, the enabled communication link between the AP MLD and the Non-AP MLD, or the remaining communication link between the AP MLD, after invalidating part of the enabled links, and the Non-AP MLD, which are not limited here.

In other words, for Non-AP MLD, it is to send a multi-link operation update request frame for the first communication link to request an update of the operation parameters corresponding to each first communication link, such as updating the device capability information of the STA device associated with each first communication link.

Optionally, the first message frame includes a category field, and the category field indicates, through a first value, that the category of the first message frame is a protected extremely high throughput (EHT) action category.

Optionally, the first message frame includes a protected EHT action field, and the protected EHT action field indicates, through a second value, that the first message frame is used for responding to the multi-link operation parameter update request (Multi-link Operation Update Response).

Optionally, the first message frame further includes a dialog token field, the ID value of the dialog token field is the same as the ID value of the dialog token field in the multi-link operation update request frame sent by the Non-AP MLD, and is used for indicating that the first message frame and the multi-link operation update request frame belong to the same session, that is, used for indicating that the first message frame is used for the multi-link operation update response.

Optionally, the first message frame may include a first information field. The first information field is used for respectively indicating that the AP MLD approves or rejects the operation parameter update request corresponding to each first communication link, and is used for indicating the number of the first communication link, that is, the first information field is used for indicating the number of first communication links for which operation parameter update requests are responded by the AP MLD.

As an example, when the first message frame includes the first information field, part of the information fields in the first message frame may be as follows.

| | | | |
|---|---|---|---|
| Category | Protected | Dialog Token | First Information Field |
| | EHT Action | | |

Optionally, the first message frame may include a second information field and a third information field. The second information field is used for respectively indicating that the AP MLD approves or rejects the operation parameter update request corresponding to each first communication link, and the third information field is used for indicating the number of the first communication link, that is, the third information field is used for indicating the number of first communication links for which the operation parameter update requests are responded by the AP MLD.

As an example, when the first message frame includes the second information field and the third information field, part of the information fields in the first message frame may be as follows.

| | | | | |
|---|---|---|---|---|
| Category | Protected | Dialog | Second | Third |
| | EHT Action | Token | Information Field | Information Field |

In step S22, the first message frame is sent.

After Non-AP MLD determines the first message frame, the first message frame may be sent to the Non-AP MLD, where the first message frame is used for responding to the multi-link operation update request frame.

In the communication method applied to AP MLD according to some embodiments of the present disclosure, when the first message frame includes the first information field, the first information field includes an update status info (information) control field and an update status info (information) list field.

The update status information control field is used for indicating the number of first communication links, and the update status information list field is used for respectively indicating that the AP MLD approves or rejects the operation parameter update request corresponding to each first communication link.

In other words, for the AP MLD, it sends a first message frame, where the first message frame includes a first information field, the AP MLD indicates, through the update status information control field in the first information field, the number of first communication links. The update status information list field in the first information field is used for respectively indicating that the AP MLD approves or rejects the operation parameter update request corresponding to each first communication link.

As an example, part of the information fields in the first information field may be as follows.

| | |
|---|---|
| Update Status Info Control | Update Status Info List |

In the communication method applied to AP MLD according to some embodiments of the present disclosure, when the first message frame includes the first information field, the first information field includes an update status information control field, the update status information control field includes an update status count field, and the update status count field is used for indicating the number of first communication links.

The number indicated by the update status count field is consistent with the number of Per-STA profile fields or link ID fields included in the multi-link operation update request frame.

The number of first communication links indicated by the update status count field is consistent with the number of Per-STA Profile fields or link ID fields included in the multi-link operation update request frame.

As an example, the update status information control field may be as follows.

| | |
|---|---|
| Update Status Count | Reserved |

Reserved is a reserved bit.

In the communication method applied to the AP MLD according to some embodiments of the present disclosure, when the first message frame includes the first information field, the first information field includes an update status count field and an update status info list field. The update status count field is used for indicating the number of first communication links, and the update status info list field is used for respectively indicating that the AP MLD approves or rejects an operation parameter update request corresponding to each first communication link.

The number indicated by the update status count field is consistent with the number of Per-STA profile fields or link ID fields included in the multi-link operation update request frame.

As an example, part of the information fields in the first information field may be as follows.

| | |
|---|---|
| Update Status Count | Update Status Info List |

In the communication method applied to the AP MLD according to some embodiments of the present disclosure, when the first message frame includes the first information field, that is, when the AP MLD respectively indicates, through the first information field in the first message frame, that the AP MLD approves or rejects the operation parameter update request corresponding to each first communication link and the number of first communication links, the first message field may be an update status info field.

As an example, part of the information fields in the first message frame may be as follows.

| | | | |
|---|---|---|---|
| Category | Protected EHT Action | Dialog Token | Update Status Info |

In the communication method applied to AP MLD according to some embodiments of the present disclosure, when the first message frame includes the second information field and the third information field, the second information field is the update status info list field, and the third information field is the update status count field.

In the case where the first message frame includes the update status information list field and the update status count field, the AP MLD respectively indicates, through the update status information list field, that the AP MLD approves or rejects the operation parameter update request corresponding to each first communication link, and indicates the number of first communication links through the update status count field.

As an example, part of the information fields of the first message frame may be as follows.

| | | | | |
|---|---|---|---|---|
| Category | Protected | Dialog | Update Status | Update |
| | EHT Action | Token | Info List | Status Count |

The number of first communication links indicated by the update status count field is consistent with the number of Per-STA profile fields or link ID fields included in the multi-link operation update request frame.

In the communication method applied to the AP MLD according to some embodiments of the present disclosure, the first information field or the second information field may include at least one per-link update status information (Info) field, where each per-link update status information field is used for indicating that the AP MLD approves or rejects an operation parameter update request corresponding to one of first communication links.

The number of per-link update status information fields in the first information field or the second information field is the same as the number of first communication links, that is, the number of per-link update status information fields in the first information field or the second information field is consistent with the number of Per-STA profile fields or link ID fields included in the multi-link operation update request frame.

As an example, the first information field or the second information field may include multiple per-link update status information fields, where each per-link update status information field is used for indicating the operation parameter update request corresponding to one of the first communication links, and the first information field may be as follows.

| | | | |
|---|---|---|---|
| Per-Link Update | Per-Link Update | Per-Link Update | . . . |
| Status Info | Status Info | Status Info | |

In the communication method applied to AP MLD according to some embodiments of the present disclosure, each per-link update status information field includes a link information (Info) field and a status field.

The link information field is used for indicating a link ID of a first communication link, and the status field indicates, through a first value, that the AP MLD approves the operation parameter update request corresponding to the first communication link indicated by the link ID, and indicates, through a second value, that the AP MLD rejects the operation parameter update request corresponding to the first communication link indicated by the link ID.

In other words, for each per-link update status information field, the per-link update status information field can indicate a link ID of a first communication link through the link information field, and the per-link update status information field indicates, through the ID value of the status field, that the AP MLD rejects or approves the operation parameter update request corresponding to the first communication link indicated by the link ID.

The first value and the second value are different values, which are not limited here. For example, the first value may be 0, and the second value may be 141.

As an example, when the first value is 0 and the second value is 141, for any per-link update state information field, if the first communication link indicated by the link ID of the link information field in the per-link update state information field is link1, and when the ID value of the status field in the per-link update state information field is 141, it indicates that the AP MLD rejects the operation parameter update request corresponding to link1 (DENIED_OPERATION_PARAMETER_UPDATE). When the ID value of the status field in the per-link update state information field is 0, it indicates the AP MLD approves the operation parameter update request corresponding to link1.

As an example, the per-link update status information field may be as follows.

| | |
|---|---|
| Link Info | Status |

The ID value of the link information field in each per-link update status information field is consistent with the ID value of a link ID field in the Per-STA profile field included in the multi-link operation update request frame, that is, the link ID indicated by the link information field in each per-link update status information field corresponds to one first communication link.

In the communication method applied to AP MLD according to some embodiments of the present disclosure, the first information field or the second information field includes an update status information (Info) list field, and the update status information list field includes at least one per-link update status information field.

The number of per-link update status information fields in the update status information list field is the same as the number of first communication links, that is, the number of per-link update status information fields in the update status information list field is consistent with the number of Per-STA profile fields or link ID fields included in the multi-link operation update request frame.

As an example, the AP MLD sends a first message frame. When the first message frame includes a first information field, the first information field includes an update status information list field. The update status information list field includes at least one per-link update status information field. Each per-link update status information field is used for indicating that the AP MLD approves or rejects an operation parameter update request corresponding to a first communication link.

As an example, the AP MLD sends a first message frame. When the first message frame includes a first information field, the first information field is an update status information field. The update status information field includes an update status information list field. The update status information list field includes at least one per-link update status information field. Each per-link update status information field is used for indicating that the AP MLD approves or rejects an operation parameter update request corresponding to a first communication link.

As an example, when the AP MLD sends the first message frame including a second information field and a third information field, the second information field is the update status information list field, and the update status information list field includes at least one per-link update status information field, each of which is used for indicating that the AP MLD approves or rejects an operation parameter update request corresponding to a first communication link. That is, the first message frame indicates, through each per-link update status information field in the second information field, that the AP MLD approves or rejects the operation parameter update request corresponding to one first communication link, and indicates the number of first communication links through the third information field.

In the communication method applied to AP MLD according to some embodiments of the present disclosure, the first message frame is a multi-link operation update response frame. That is, after receiving the multi-link operation update request frame sent by the Non-AP MLD, the AP MLD sends the multi-link operation update response frame to the Non-AP MLD. The multi-link operation update response frame is used for respectively indicating that the AP MLD approves or rejects the operation parameter update request corresponding to each first communication link.

It should be noted that, in the communication method applied to AP MLD according to some embodiments of the present disclosure, when the first message frame includes the first information field, the first information field may specifically indicate the number of first communication links through the update status count field, and the first information field may directly include the update status count field. Alternatively, the first information field may include the update status information control field, and the update status count field may be included in the update status information control field. Also, the first information field may directly include at least one per-link update status information field; and may also include an update status information list field including at least one per-link update status information field, so as to indicate, through each per-link update status information field, that the AP MLD approves or rejects the operation parameter update request corresponding to the first communication link.

In case that the first message frame includes the second information field and the third information field, the second information field may directly include at least one per-link update status information field; and may also include the update status information list field, including at least one per-link update status information field, so that each per-link update status information field indicates that the AP MLD approves or rejects the operation parameter update request corresponding to the first communication link. Also, the number of first communication links is indicated through the third information field.

The embodiments of the present disclosure provide a communication method that can be applied to Non-AP MLD. As shown in FIG. 3 for details, it is another schematic flow chart of a communication method according to an embodiment of the present disclosure. Optionally, the method may include the following step(s).

In step S31, the first message frame is received, where the first message frame includes the first information field, which is used for respectively indicating that the AP MLD approves or rejects the operation parameter update request corresponding to each first communication link, and indicating the number of first communication links; or,
the first message frame includes a second information field and a third information field, where the second information field is used for indicating that the AP MLD approves or rejects the operation parameter update request corresponding to each first communication link, and the third information field is used for indicating the number of first communication links.

In some embodiments of the present disclosure, each first communication link is a communication link for Non-AP MLD to request update of multi-link operation parameters.

The first communication link is the communication link for Non-AP MLD to request the update of multi-link operation parameters, including but not limited to a communication link established between the AP device, after being added by AP MLD, and the STA attached to Non-AP MLD, a communication link established between the attached AP device, before being removed by AP MLD, and the STA attached to Non-AP MLD, a communication link with Non-AP MLD enabled by AP MLD, or an enabled communication link with Non-AP MLD invalidated by AP MLD, or the like, which is not limited here.

That is, for Non-AP MLD, it is to send the multi-link operation update request frame for the first communication link(s) to request an update of the operation parameters corresponding to each first communication link, such as updating the device capability information of the STA device associated with each first communication link.

Optionally, the first message frame includes the category field, and the category field indicates that the category of the first message frame is the protected EHT action category.

Optionally, the first message frame includes the protected EHT action field, which indicates, through the second value, that the first message frame is used for responding to the multi-link operation parameter update request (multi-link operation update response).

Optionally, the first message frame also includes a dialog token. The ID value of the dialog token field in the multi-link operation update request frame sent by the Non-AP MLD is the same as the ID value of the dialog token field in the multi-link operation update request frame, which is used for indicating that the first message frame and the multi-link operation update request frame belong to the same session, that is, the first message frame is used for responding to the multi-link operation parameter update request.

Optionally, the first message frame may include a first information field. The first information field is used for respectively indicating that the AP MLD approves or rejects the operation parameter update request corresponding to each first communication link, and used for indicating the number of first communication links at the same time, that is, the first information field is used for indicating the number of first communication links for which the operation parameter update requests are responded by the AP MLD.

As an example, when the first message frame includes the first information field, part of the information fields in the first message frame may be as follows.

| | | | |
|---|---|---|---|
| Category | Protected | Dialog | First |
| | EHT Action | Token | Information Field |

Optionally, the first message frame may include the second information field and the third information field. The second information field is used for respectively indicating that the AP MLD approves or rejects the operation parameter update request corresponding to each first communication link, and the third information field is used for indicating the number of first communication links. That is, the third information field is used for indicating the number of first communication links for which the operation parameter update requests are responded by the AP MLD.

As an example, when the first message frame includes the second information field and the third information field, part of the information fields in the first message frame may be as follows.

| | | | | |
|---|---|---|---|---|
| Category | Protected | Dialog | Second | Third |
| | EHT Action | Token | Information Field | Information Field |

In the communication method applied to Non-AP MLD according to some embodiments of the present disclosure, when the first message frame includes the first information field, the first information field includes the update status info (information) control field and the update status info list field.

The update status information control field is used for indicating the number of first communication links, and the update status information list field is used for respectively indicating that the AP MLD approves or rejects the operation parameter update request corresponding to each first communication link.

In other words, for the AP MLD, it sends the first message frame, the first message frame includes the first information field, and the AP MLD indicates, through the update status information control field in the first information field, the number of first communication links. The update status information list field in the first information field is used for respectively indicating that the AP MLD approves or rejects the operation parameter update request corresponding to each first communication link.

As an example, part of the information fields in the first information field may be as follows.

| | |
|---|---|
| Update Status Info Control | Update Status Info List |

In the communication method applied to Non-AP MLD according to an embodiment of the present disclosure, when the first message frame includes the first information field, the first information field includes an update status information control field, which includes an update status number (Count) field, and the update status number field is used for indicating the number of first communication links.

The number indicated by the update status count field is consistent with the number of Per-STA profile fields or link ID fields included in the multi-link operation update request frame.

The number of first communication links indicated by the update status count field is consistent with the number of Per-STA Profile fields or link ID fields included in the multi-link operation update request frame.

As an example, the update status information control field may be as follows.

| | |
|---|---|
| Update Status Count | Reserved |

Reserved represents a reserved bit.

In the communication method applied to the Non-AP MLD according to some embodiments of the present disclosure, when the first message frame includes the first information field, the first information field includes the update status count field and the update status info list field. The update status count field is used for indicating the number of first communication links, and the update status info list field is used for respectively indicating that the AP MLD approves or rejects an operation parameter update request corresponding to each first communication link.

The number indicated by the update status count field is consistent with the number of Per-STA profile fields or link ID fields included in the multi-link operation update request frame.

As an example, part of the information fields in the first information field may be as follows.

| | |
|---|---|
| Update Status Count | Update Status Info List |

In the communication method applied to the Non-AP MLD according to some embodiments of the present disclosure, when the first message frame includes the first information field, that is, when the AP MLD respectively indicates, through the first information field in the first message frame, that the AP MLD approves or rejects the operation parameter update request corresponding to each first communication link and the number of first communication links, the first message field may be the update status info field.

As an example, part of the information fields in the first message frame may be as follows.

| | | | |
|---|---|---|---|
| Category | Protected EHT Action | Dialog Token | Update Status Info |

In the communication method applied to Non-AP MLD according to some embodiments of the present disclosure, when the first message frame includes the second information field and the third information field, the second information field is the update status info list field, and the third information field is the update status count field.

In case the first message frame includes the update status information list field and the update status count field, the AP MLD indicates, through the update status information list field, that the AP MLD approves or rejects the operation parameter update request corresponding to each first communication link, and indicates the number of first communication links through the update status count field.

As an example, part of the information fields in the first message frame may be as follows.

| | | | | |
|---|---|---|---|---|
| Category | Protected | Dialog | Update Status | Update |
| | EHT Action | Token | Info List | Status Count |

The number of first communication links indicated by the update status count field is consistent with the number of Per-STA profile fields or link ID fields included in the multi-link operation update request frame.

In the communication method applied to the Non-AP MLD according to some embodiments of the present disclosure, the first information field or the second information field may include at least one per-link update status information (Info) field, where each per-link update status information field is used for indicating that the AP MLD approves or rejects the operation parameter update request corresponding to one of the first communication links.

The number of per-link update status information fields in the first information field or the second information field is the same as the number of first communication links, that is, the number of per-link update status information fields in the first information field or the second information field is consistent with the number of Per-STA profile fields or link ID fields included in the multi-link operation update request frame.

As an example, the first information field or the second information field may include multiple per-link update status information fields, where each per-link update status information field is used for indicating the operation parameter update request corresponding to one of the first communication links, and the first information field may be as follows.

| | | | |
|---|---|---|---|
| Per-Link Update | Per-Link Update | Per-Link Update | . . . |
| Status Info | Status Info | Status Info | |

In the communication method applied to Non-AP MLD according to some embodiments of the present disclosure, each per-link update status information field includes the link information (Info) field and the status field.

The link information field is used for indicating a link ID of one first communication link, and the status field indicates, through the first value, that the AP MLD approves the operation parameter update request corresponding to the first communication link indicated by the link ID, and indicates, through the second value, that the AP MLD rejects the operation parameter update request corresponding to the first communication link indicated by the link ID.

In other words, for each per-link update status information field, the per-link update status information field can indicate a link ID of a first communication link through the link information field, and the per-link update status information field indicates, through the ID value of the status field, that the AP MLD rejects or approves the operation parameter update request corresponding to the first communication link indicated by the link ID.

The first value and the second value are different values, which are not limited here. For example, the first value may be 0, and the second value may be 141.

As an example, when the first value is 0 and the second value is 141, for any per-link update state information field, if the first communication link indicated by the link ID of the link information field in the per-link update state information field is link1, when the ID value of the status field in the per-link update state information field is 141, it indicates that the AP MLD rejects the operation parameter update request corresponding to link1. When the ID value of the status field in the per-link update state information field is 0, it indicates that the AP MLD i approves the operation parameter update request corresponding to link1.

As an example, the per-link update status information field may be as follows.

| | |
|---|---|
| Link Info | Status |

The ID value of the link information field in each per-link update status information field is consistent with the ID value of a link ID field in the Per-STA profile field included in the multi-link operation update request frame, that is, the link ID indicated by the link information field in each per-link update status information field corresponds to one first communication link.

In the communication method applied to Non-AP MLD according to some embodiments of the present disclosure, the first information field or the second information field includes an update status information (Info) list field, and the update status information list field includes at least one per-link update status information field.

The number of per-link update status information fields in the update status information list field is the same as the number of first communication links, that is, the number of per-link update status information fields in the update status information list field is consistent with the number of Per-STA profile fields or link ID fields included in the multi-link operation update request frame.

As an example, the AP MLD sends the first message frame. When the first message frame includes the first information field, the first information field includes the update status information list field. The update status information list field includes at least one per-link update status information field. Each per-link update status information field is used for indicating that the AP MLD approves or rejects the operation parameter update request corresponding to the first communication link.

As an example, the AP MLD sends the first message frame. When the first message frame includes the first information field, the first information field includes the update status information list field. The update status information list field includes at least one per-link update status information field. Each per-link update status information field is used for indicating that the AP MLD approves or rejects the operation parameter update request corresponding to the first communication link.

As an example, when the AP MLD sends the first message frame including the second information field and the third information field, where the second information field is the update status information list field. The update status information list field includes at least one per-link update status information field, each of which is used for indicating that the AP MLD approves or rejects the operation parameter update request corresponding to one first communication link. That is, the first message frame indicates, through each per-link update status information field in the second information field, that the AP MLD approves or rejects the operation parameter update request corresponding to one first communication link, and indicates the number of first communication links through the third information field.

In the communication method applied to the Non-AP MLD according to some embodiments of the present disclosure, the first message frame is the multi-link operation update response frame. That is, after receiving the multi-link operation update request frame sent by the Non-AP MLD, the AP MLD sends the multi-link operation update response frame to the Non-AP MLD. The multi-link operation update response frame is used for respectively indicating that the AP MLD approves or rejects the operation parameter update request corresponding to each first communication link.

It should be noted that, in the communication method applied to the Non-AP MLD according to some embodiments of the present disclosure, when the first message frame includes the first information field, the first information field may specifically indicate the number of first communication links through the update status count field, and the first information field may directly include the update status count field. Alternatively, the first information field may include the update status information control field, in which the update status count field may be included. Moreover, the first information field may directly include at least one per-link update status information field, and may also include an update status information list field in which at least one per-link update status information field is included, so as to indicate, through each per-link update status information field, that the AP MLD approves or rejects the operation parameter update request corresponding to the first communication link.

In case the first message frame includes the second information field and the third information field, the second information field may directly include at least one per-link update status information field, and may also include the update status information list field in which at least one per-link update status information field is included, so that each per-link update status information field indicates that the AP MLD approves or rejects the operation parameter update request corresponding to the first communication link. Moreover, the number of first communication links is indicated through the third information field.

As an example, the communication method according to some embodiments of the present disclosure is further described below with reference to FIG. 4.

After AP MLD and non-AP MLD negotiate and successfully establish multiple links, the AP MLD and non-AP MLD can communicate with each other.

After AP MLD adds or removes an attached AP, enables a communication link, or disables an enabled communication link, Non-AP MLD can initiate the multi-link operation parameter update through the multi-link operation update request frame, thereby updating the operation parameters corresponding to the involved communication links.

The multi-link operation update request frame includes at least one Per-STA profile field, where each Per-STA profile field includes an STA control field, the STA control field includes a link ID field, and each link ID field indicates one first communication link through an ID value, and is used for requesting an update of the operation parameters corresponding to the first communication link.

The first communication link is the communication link for which the Non-AP MLD requests to update the multi-link operation parameters, including but not limited to a communication link established between the AP device, after being added by AP MLD, and the STA attached to the Non-AP MLD, a remaining established communication link between the AP device, after being removed by AP MLD, and the STA attached to the Non-AP MLD, an enabled communication link between the AP MLD and the Non-AP MLD, or a remaining communication link between the AP MLD and the Non-AP MLD after part of enabled links are invalidated by the AP MLD, and the like, which are not limited here.

The multi-link operation update request frame includes a reconfiguration multi-link information element field, which includes a link info (information) field, and the link information field includes a Per-STA profile field.

After receiving the request frame, the AP MLD determines and sends a multi-link operation update response frame to the Non-AP MLD.

The multi-link operation update response frame includes the category field, which indicates, through the first value, that the category of the multi-link operation update response frame is the protected EHT action category.

The multi-link operation update response frame includes the protected EHT action field. The protected EHT action field indicates, through the second value, that the multi-link operation update response frame is used for responding to the multi-link operation parameter update request (multi-link operation update response).

The multi-link operation update response frame also includes the dialog token field, where the ID value of the dialog token field is the same as the ID value of the dialog token field in the multi-link operation update request frame sent by the Non-AP MLD, which is used for indicating that the multi-link operation update response frame and the multi-link operation update request frame belong to the same session, that is, used for indicating that the multi-link operation update response frame is used for responding to the multi-link operation parameter update request.

In an embodiment, the multi-link operation update response frame includes the update status information field, where the update status information field includes the status information control field, the status information control field includes the update status count field, and the multi-link operation update response frame indicates, through the update status count field, the number of first communication links.

The update status information field in the multi-link operation update response frame further includes an update status information list field, where the update status information list field includes at least one per-link update status information field, and each per-link update status information field is used for indicating the operation parameter update request corresponding to one first communication link.

In an embodiment, the multi-link operation update response frame includes an update status count field and an update status information list field. The multi-link operation update response frame indicates the number of first communication links through the update status count field. The update status information list field includes at least one per-link update status information field. Each per-link update status information field is used for indicating the operation parameter update request corresponding to one first communication link.

In any one of the foregoing embodiments, each per-link update state information field includes the link info field and the status field. The link info field is used for indicating the link ID of the first communication link, and the status field indicates, through the first value, that the AP MLD approves the operation parameter update request corresponding to the first communication link indicated by the link info field, and indicates, through the second value, that the AP MLD rejects the operation parameter update request corresponding to the first communication link indicated by the link info field.

The first value may be 0, and the second value may be 141. For any per-link update state information field, if the ID value of the status field in the per-link update state information field is 141, it is used for indicating that the AP MLD rejects the operation parameter update request corresponding to the first communication link indicated by the link information field in the same per-link update state information field (DENIED_OPERATION_PARAMETER_UPDATE). If the ID value of the status field in the per-link update state information field is 0, it is used for indicating that the AP MLD approves the operation parameter update request corresponding to the first communication link indicated by the link information field in the same per-link update state information field.

The ID value of the link information field in each per-link update status information field is the same as the ID value of a link ID field in the multi-link operation update request frame, and the number of Per-STA profile fields in the multi-link operation update request frame is the same as the number of first communication links. Each Per-STA profile field includes a STA control field, and the STA control field of each Per-STA profile field indicates one first communication link through the ID value of a link ID field.

Based on the communication method according to some embodiments of the present disclosure, after receiving the multi-link operation update request frame sent by the non-AP MLD to request the operation parameter update for at least one first communication link, the AP MLD may send the first message frame to the non-AP MLD, where the first message frame is used for indicating that the AP MLD approves or rejects the operation parameter update request corresponding to each first communication link, and indicating the number of first communication links.

As shown in FIG. 5, the embodiments of the present disclosure provide a communication apparatus, including:
a determining unit 51, configured to determine a first message frame, where the first message frame includes a first information field, and the first information field is used for respectively indicating approval or rejection of the operation parameter update request corresponding to each first communication link, and is used for indicating the number of the first communication link; or,
the first message frame includes a second information field and a third information field, where the second information field is used for respectively indicating approval or rejection of the operation parameter update request corresponding to each first communication link, and the third information field is used for indicating the number of the first communication link;
each first communication link is the communication link for the non-access-point multi-link device Non-AP MLD to request the multi-link operation parameter update; and
a first communication unit 52, configured to send the first message frame.

Optionally, in some embodiments of the present disclosure, the first information field includes an update status information control field and an update status information list field, where the update status information control field is used for indicating the number of the first communication link, and the update status information list field is used for respectively indicating approval or rejection of the operation parameter update request corresponding to each first communication link.

Optionally, in some embodiments of the present disclosure, the update status information control field includes an update status count field, where the status information control field indicates the number of the first communication link through the update status count field.

Optionally, in some embodiments of the present disclosure, the first information field is the update status information field.

Optionally, in some embodiments of the present disclosure, the second information field is the update status information list field, and the third information field is the update status count field.

Optionally, in some embodiments of the present disclosure, the update status information list field includes at least a per-link update status information field, and each per-link update status information field is used for indicating approval or rejection of the operation parameter update request corresponding to one of first communication links.

Optionally, in some embodiments of the present disclosure, each per-link update status information field includes a link information field and a status field, where the link information field is used for indicating the link ID of one first communication link, and the status field indicates, through a first value, approval of an operation parameter update request corresponding to the first communication link indicated by the link ID, and indicates, through a second value, rejection of an operation parameter update request corresponding to the first communication link indicated by the link ID.

Optionally, in some embodiments of the present disclosure, the first message frame is the multi-link operation update response frame.

As shown in FIG. 6, the embodiments of the present disclosure provide a communication apparatus, including:
a second communication unit 61, configured to receive a first message frame, where the first message frame includes a first information field, and the first information field is used for respectively indicating approval or rejection of the operation parameter update request corresponding to each first communication link, and is used for indicating the number of the first communication link; or,
the first message frame includes a second information field and a third information field, where the second information field is used for respectively indicating approval or rejection of the operation parameter update request corresponding to each first communication link, and the third information field is used for indicating the number of the first communication link;
each first communication link is a communication link for the Non-AP MLD to request the multi-link operation parameter update.

Optionally, in some embodiments of the present disclosure, the first information field includes an update status information control field and an update status information list field, where the update status information control field is used for indicating the number of the first communication link, and the update status information list field is used for respectively indicating approval or rejection of the operation parameter update request corresponding to each first communication link.

Optionally, in some embodiments of the present disclosure, the update status information control field includes an update status count field, and the status information control field indicates the number of the first communication link through the update status count field.

Optionally, in some embodiments of the present disclosure, the first information field is the update status information field.

Optionally, in some embodiments of the present disclosure, the second information field is the update status information list field, and the third information field is the update status count field.

Optionally, in some embodiments of the present disclosure, the update status information list field includes at least a per-link update status information field, and each per-link update status information field is used for indicating approval or rejection of the operation parameter update request corresponding to one of first communication links.

Optionally, in some embodiments of the present disclosure, each per-link update status information field includes a link information field and a status field, where the link information field is used for indicating the link ID of one first communication link, and the status field indicates, through a first value, approval of an operation parameter update request corresponding to the first communication link indicated by the link ID, and indicates, through a second value, rejection of an operation parameter update request corresponding to the first communication link indicated by the link ID.

Optionally, in some embodiments of the present disclosure, the first message frame is the multi-link operation update response frame.

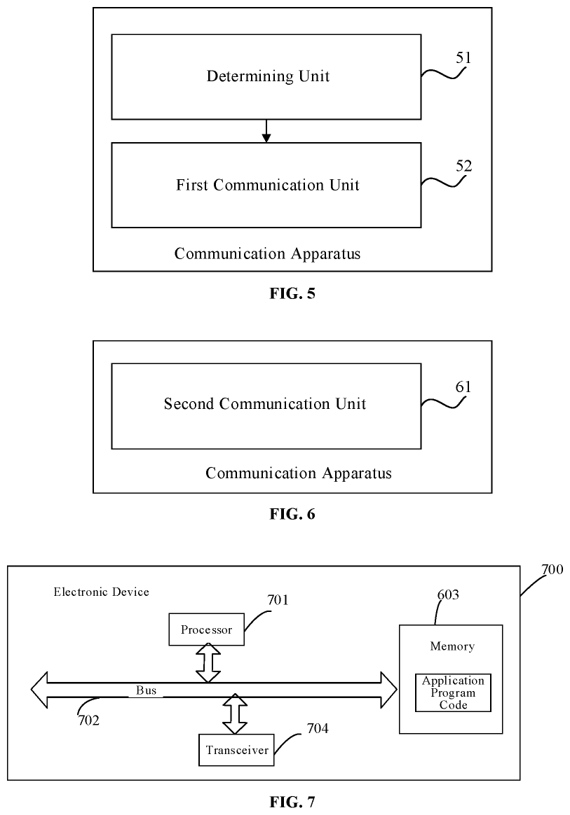

The embodiments of the present disclosure further provide an electronic device, as shown in FIG. 7. The electronic device 700 shown in FIG. 7 includes a processor 701 and a memory 703. The processor 701 and the memory 703 are connected. For example, the processor 701 and the memory 703 are connected through a bus 702. Optionally, the electronic device 700 may further include a transceiver 704. It should be noted that in actual applications, the number of transceivers 704 is not limited to one, and the structure of the electronic device 700 does not constitute a limitation on the embodiments of the present disclosure.

Memory 703 is used for storing application code for executing the embodiments of the present disclosure, and is controlled by processor 701 for execution. When electronic device 700 functions as the AP MLD, processor 701 is used for executing application code stored in memory 703 to implement the communication method for the AP MLD according to some embodiments of the present disclosure. When electronic device 700 functions as a Non-AP MLD, processor 701 is used for executing application code stored in memory 703 to implement the communication method for a Non-AP MLD according to some embodiments of the present disclosure.

Bus 702 may include a path for transmitting information between the foregoing components. Bus 702 may include a peripheral component interconnect (PCI) bus or an extended industry standard architecture (EISA) bus or the like. Bus 702 may include an address bus, a data bus, a control bus and the like. For ease of illustration, the bus is shown by only one thick line in FIG. 7, but it does not mean that only one bus or only one type of bus exists.

The memory 703 may be a read only memory (ROM) or other type of static storage device that can store static information and instructions, a random access memory (RAM) or other type of dynamic storage device that can store information and instructions, or an electrically erasable programmable read only memory (EEPROM), a compact disc read only memory (CD-ROM) or other optical disc storage, optical disc storage (including compact discs, laser discs, optical discs, digital versatile discs, blue-ray discs and the like), a magnetic disk storage medium or other magnetic storage device, or any other medium that can be used for carrying or storing desired program code in the form of instructions or data structures and can be accessed by a computer, which is not limited to these.

Some embodiments of the present disclosure provide a computer-readable storage medium storing a computer program, where the computer program, upon running on the computer, cause the computer to implement the corresponding contents of the foregoing method embodiments.

It should be understood that although the steps in the flowcharts of the accompanying drawings are shown in sequence as indicated by the arrows, these steps are not necessarily executed in the order indicated by the arrows. Unless specified herein, there is no strict order restriction on the execution of these steps, and they can be executed in other orders. Moreover, at least some of the steps in the flowcharts of the accompanying drawings may include multiple sub-steps or multiple stages, and these sub-steps or stages are not necessarily executed at the same time, but can be executed at different times, and their execution order is not necessarily sequential, but can be executed in turn or alternately with other steps or at least a portion of the sub-steps or stages of other steps.

It should be noted that the foregoing computer-readable storage medium described in the present disclosure may include a computer-readable signal medium or a computer-readable storage medium, or any combination thereof. The computer-readable storage medium may include, for example, but not limited to, an electrical, magnetic, optical, electromagnetic, infrared, or semiconductor system, apparatus, or device, or any combination thereof. More specific examples of computer-readable storage medium may include, but are not limited to, an electrical link having one or more conductors, a portable computer disk, a hard disk, random access memory (RAM), read-only memory (ROM), erasable programmable read-only memory (EPROM or flash memory), optical fiber, a portable compact disk read-only memory (CD-ROM), an optical storage device, a magnetic storage device, or any suitable combination thereof. In the present disclosure, a computer-readable storage medium may be any tangible medium containing or storing a program that can be used by or in conjunction with an instruction execution system, apparatus, or device. In the present disclosure, the computer-readable signal medium may include a data signal propagated in baseband or as part of a carrier wave, carrying computer-readable program code. Such a propagated data signal may take a variety of forms, including, but not limited to, electromagnetic signals, optical signals, or any suitable combination thereof. The computer-readable signal medium may also be any computer-readable storage medium other than a computer-readable storage medium that can transmit, propagate, or transport a program for use by or in link with an instruction execution system, apparatus, or device. Program code embodied on a computer-readable storage medium may be transmitted using any suitable medium, including but not limited to wire, optical cable, RF (radio frequency), or any suitable combination thereof.

The computer-readable storage medium may be included in the AP MLD or the Non-AP MLD; or may exist independently without being assembled into the AP MLD or the Non-AP MLD.

The computer-readable storage medium carries one or more programs. When the one or more programs are executed by the AP MLD or the Non-AP MLD, the AP MLD or the Non-AP MLD executes a corresponding communication method.

According to one aspect of the present disclosure, a computer program product or computer program is provided, including computer instructions stored in a computer-readable storage medium. A processor of a computer device reads the computer instructions from the computer-readable storage medium and executes the computer instructions, causing the computer device to perform the communication methods according to the various optional embodiments described above.

Computer program code for carrying out operations of the present disclosure may be written in one or more programming languages, or a combination thereof. The programming languages include object-oriented programming languages such as Java, Smalltalk, C++, and conventional procedural programming languages such as “C” or similar programming languages. The program code may be executed entirely on the computer of user, partially on the computer of user, as a stand-alone software package, partially on the computer of user and partially on a remote computer, or entirely on a remote computer or server. In cases involving a remote computer, the remote computer may be connected to the computer of user through any type of network, including a local area network (LAN) or a wide area network (WAN), or may be connected to an external computer (e.g., through the Internet using an Internet service provider).

The flowcharts and block diagrams in the accompanying drawings illustrate the possible implementation architecture, functions and operations of the systems, methods and computer program products according to various embodiments of the present disclosure. In this regard, each box in the flowchart or block diagram can represent a module, program segment, or a part of code, and the module, program segment, or part of code includes one or more executable instructions for realizing the specified logical function. It should also be noted that in some alternative implementations, the functions marked in the box can also occur in a different order than that marked in the accompanying drawings. For example, two boxes represented in succession can actually be executed substantially in parallel, and they can sometimes be executed in the opposite order, depending on the functions involved. It should also be noted that each box in the block diagram and/or flowchart, and the combination of the boxes in the block diagram and/or flowchart, can be implemented with a dedicated hardware-based system that performs the specified function or operation, or can be implemented with a combination of dedicated hardware and computer instructions.

Modules described in some embodiments of the present disclosure may be implemented in software or hardware. In some cases, the name of a module does not necessarily define the module itself. For example, module A may also be described as “module A for performing operation B.”

The foregoing description includes merely preferred embodiments of the present disclosure and illustration of the technical principles employed. Those skilled in the art should understand that the scope of the present disclosure is not limited to technical solutions formed by specific combinations of the aforementioned technical features, but should also include other technical solutions formed by any combination of the aforementioned technical features or their equivalents, without departing from the scope of the foregoing disclosure. For example, a technical solution formed by replacing the aforementioned features with technical features with similar functions disclosed (but not limited to) in the present disclosure.

1. A communication method, being applied to an access-point multi-link device AP MLD and comprising:
determining a first message frame, wherein the first message frame comprises a first information field, and the first information field is used for respectively indicating approval or rejection of an operation parameter update request corresponding to each first communication link and is used for indicating a number of the first communication link; or,
the first message frame comprises a second information field and a third information field, the second information field is used for respectively indicating approval or rejection of the operation parameter update request corresponding to each first communication link, and the third information field is used for indicating the number of the first communication link;
each first communication link is a communication link for a non-access-point multi-link device Non-AP MLD to request a multi-link operation parameter update; and
sending the first message frame.

2. The method according to claim 1, wherein the first information field comprises an update status information control field and an update status information list field, the update status information control field is used for indicating the number of the first communication link, and the update status information list field is used for respectively indicating approval or rejection of the operation parameter update request corresponding to each first communication link.

3. The method according to claim 2, wherein the update status information control field comprises an update status count field, and the status information control field indicates the number of the first communication link through the update status count field.

4. The method according to claim 1, wherein the first information field is an update status information field.

5. The method according to claim 1, wherein the second information field is an update status information list field, and the third information field is an update status count field.

6. The method according to claim 2 or 5, wherein the update status information list field comprises at least a per-link update status information field, and each per-link update status information field is used for indicating approval or rejection of an operation parameter update request corresponding to one of first communication links.

7. The method according to claim 6, wherein each per-link update status information field comprises a link information field and a status field, the link information field is used for indicating a link identifier (ID) of one first communication link, and the status field indicates, through a first value, approval of an operation parameter update request corresponding to the first communication link indicated by the link ID, and indicates, through a second value, rejection of an operation parameter update request corresponding to the first communication link indicated by the link ID.

8. The method according to claim 1, wherein the first message frame is a multi-link operation update response frame.

9. A communication method, being applied to a non-access-point multi-link device Non-AP MLD and comprising:
receiving a first message frame, wherein the first message frame comprises a first information field, and the first information field is used for respectively indicating approval or rejection of an operation parameter update request corresponding to each first communication link and is used for indicating a number of the first communication link; or,
the first message frame comprises a second information field and a third information field, the second information field is used for respectively indicating approval or rejection of the operation parameter update request corresponding to each first communication link, and the third information field is used for indicating the number of the first communication link;
each first communication link is a communication link for the Non-AP MLD to request a multi-link operation parameter update.

10. The method according to claim 9, wherein the first information field comprises an update status information control field and an update status information list field, the update status information control field is used for indicating the number of the first communication link, and the update status information list field is used for respectively indicating approval or rejection of the operation parameter update request corresponding to each first communication link.

11. The method according to claim 10, wherein the update status information control field comprises an update status count field, and the status information control field indicates the number of the first communication link through the update status count field.

12. The method according to claim 9, wherein the first information field is an update status information field.

13. The method according to claim 9, wherein the second information field is an update status information list field, and the third information field is an update status count field.

14. The method according to claim 10 or 13, wherein the update status information list field comprises at least a per-link update status information field, and each per-link update status information field is used for indicating approval or rejection of an operation parameter update request corresponding to one of first communication links.

15. The method according to claim 14, wherein each per-link update status information field comprises a link information field and a status field, the link information field is used for indicating a link ID of one first communication link, and the status field indicates, through a first value, approval of an operation parameter update request corresponding to the first communication link indicated by the link ID, and indicates, through a second value, rejection of an operation parameter update request corresponding to the first communication link indicated by the link ID.

16. The method according to claim 9, wherein the first message frame is a multi-link operation update response frame.

17. A communication apparatus, comprising:
a determining unit, configured to determine a first message frame, wherein the first message frame comprises a first information field, and the first information field is used for respectively indicating approval or rejection of an operation parameter update request corresponding to each first communication link, and is used for indicating a number of the first communication link; or,
the first message frame comprises a second information field and a third information field, the second information field is used for respectively indicating approval or rejection of the operation parameter update request corresponding to each first communication link, and the third information field is used for indicating the number of the first communication link;
each first communication link is a communication link for a non-access-point multi-link device Non-AP MLD to request a multi-link operation parameter update; and
a first communication unit, configured to send the first message frame.

18. A communication apparatus, comprising:
a second communication unit, configured to receive a first message frame, wherein the first message frame comprises a first information field, and the first information field is used for respectively indicating approval or rejection of an operation parameter update request corresponding to each first communication link, and is used for indicating a number of the first communication link; or,
the first message frame comprises a second information field and a third information field, the second information field is used for respectively indicating approval or rejection of the operation parameter update request corresponding to each first communication link, and the third information field is used for indicating the number of the first communication link;
each first communication link is a communication link for the Non-AP MLD to request a multi-link operation parameter update.

19. An electronic device, comprising a memory, a processor and a computer program stored in the memory and executable on the processor, wherein the processor is configured to implement the method according to any one of claims 1 to 16 when executing the program.

20. A computer-readable storage medium storing a computer program, wherein the computer program, upon being executed by a processor, is used for implementing the method according to any one of claims 1 to 16.
